(19) United States
(12) Patent Application Publication
(10) Pub. No.: US 2003/0098679 A1
(43) Pub. Date: May 29, 2003

(54) Electrical apparatus, computer equipment, intelligent, and power-supply control method

(75) Inventor: Shigefumi Odaohhara, Yamato-Shi (JP)

Correspondence Address: IBM CORPORATION, PO BOX 12195, DEPT 9CCA, BLDG 002, RESEARCH TRIANGLE PARK, NC, 27709, US

(73) Assignee: INTERNATIONAL BUSINESS MACHINES CORPORATION, Armonk, NY (US)

(21) Appl. No.: 10/065,807

(22) Filed: Nov. 21, 2002

(30) Foreign Application Priority Data
Nov. 27, 2001 (JP) 2001-361326

(51) Int. Cl. G05F 1/40

(52) U.S. Cl. 323/284

(57) ABSTRACT

A computer equipment for connecting with an intelligent battery 52 to supply power from the intelligent battery 52 to a system, in which the intelligent battery 52 comprises a cell (battery cell) 61 for supplying power by discharging after being charged, a high-capacity capacitor 73 connected to a power line for supplying power from the cell 61 to a system in parallel with the cell 61, a switch (SW1) 74 for turning on/off the connection of the high-capacity capacitor 73 to the power line, and a CPU 62 for controlling the switch (SW1) 74, and the CPU 62 controls on/off of the switch (SW1) 74 based on a connection state with the system and/or a power consumption state of the system.

### BACKGROUND OF THE INVENTION

The present invention relates to an electrical apparatus or the like constituted so that a battery for discharging after being charged can be connected, more particularly an electrical apparatus or the like in which the power of the body side increases and a peak power increases.

Power is supplied to various types of electrical units including an information terminal unit represented by a notebook-type personal computer (notebook PC), a personal unit such as a PDA (Personal Digital Assistant), various types of portable audio units, and a video camera not only from an AC adapter and directly from a commercial power source but also from batteries (storage battery, secondary battery, and battery) which can be used many times while repeating charge and discharge. These batteries respectively use a nickel-hydrogen battery (NiMH battery) or a nickel-cadmium battery which has a comparatively large capacity and is inexpensive. Moreover, there are a lithium-ion battery having a high energy density for unit weight compared to a nickel-cadmium battery and a lithium-polymer battery using a solid polymer instead of liquid electrolyte.

In the case of a notebook PC, the power of the system including a CPU has recently increased and a peak power (maximum power in a short time) has rapidly increased. When a peak power increases, a problem occurs that shutdown occurs in a battery because over-current protection works when the peak power is supplied from the battery. Moreover, when a large current instantaneously circulates, a problem may occur that a voltage reaches a discharge end voltage due to a voltage drop of a battery and thereby the operation time of the battery is shortened or a phenomenon may occur that an output is shut down because a voltage reaches a voltage for protecting a low voltage.

To solve these problems, a measure of connecting a high-capacity capacitor having a small impedance (such as an electric double-layer capacitor) to the power line of a battery in parallel with the battery is studied. FIG. 5 of the accompanying drawings shows a state in which a high-capacity capacitor 202 is connected to a battery 201 in parallel. As shown in FIG. 5, when the high-capacity capacitor 202 is connected with the battery 201 in parallel, a peak power circulates through the high-capacity capacitor 202 if the load of the system is applied because the high-capacity capacitor 202 has a very small series resistance component referred to as ESR (Equivalent Series Resistance) compared to that of the battery 201. However, the battery 201 can keep a state almost close to a DC. Thus, when the current circulating through the battery 201 becomes close to a DC, an effective current decreases and thereby it is possible to lengthen the operation time of the battery 201. Moreover, because over-current protection or voltage drop does not occur in the battery 201, it is possible to prevent the above functional problems.

However, when the high-capacity capacitor 202 is connected to the battery 201 in parallel, the high-capacity capacitor 202 has problems that the large leak current increases (e.g. hundreds of mAs to several mAs) and the battery 201 easily over-discharges and is damaged. That is, when the battery 201 is normally operated, the current consumption at the system side is far larger and problems are few even if a leak current occurs. However, when the battery 201 and the high-capacity capacitor 202 are connected each other when the system is turned off, the capacity of the battery 201 decreases and becomes an over-discharge state. Moreover, because a current always circulates, the current value is at a level which is difficult to accurately measure by a current-measuring circuit. Therefore, a problem occurs that capacity errors of the battery 201 are accumulated.

### BRIEF SUMMARY OF THE INVENTION

The present invention is made to solve the above technical problems and its purpose is to reduce a peak power discharged from a battery and decrease a leak current leaking from the battery.

To achieve the above purpose, the present invention uses an electrical apparatus having a body for consuming power and a battery for supplying power to the body through a power line by discharging after being charged, comprising a high-capacity capacitor having a comparatively small impedance and connected to the power line in parallel with the battery, a switch for disconnecting or connecting the high-capacity capacitor from or to the power line by a circuit, and a controller for controlling operations of the switch.

In this case, the controller controls operations of the switch and disconnects the high-capacity capacitor by a circuit when the battery is disconnected from the body, the body is turned off, or the body is kept in a small-power-consumption mode. Therefore, the controller is preferable in that it is possible to suppress the leak current generated by the high-capacity capacitor. As the “high-capacity capacitor”, it is preferable to use a capacitor having an ESR (Equivalent Series Resistance) of 10 mW to 100 mW and a capacitance of 0.1 F to tens of Fs in order to reduce a peak power of the body. The same is applied to the following.

Moreover, the present invention is an electrical apparatus constituted so as to be able to connect with a battery for supplying power to a body, comprising a peak-power supply unit connected to a power line for supplying power from the battery to the body in parallel with the battery to supply power when a peak power is generated in the body and a disconnection unit for disconnecting the peak-power supply unit from the power line by a circuit when the body is kept in a predetermined small-power-consumption mode and/or the body is powered off while the battery is connected to the body. In this case, “peak power” denotes a large power necessary for a certain short period to a steady state.

Furthermore, the present invention is a computer equipment connected with a battery for discharging after being charged to supply power from the battery to the system, comprising a peak-power supply unit connected in parallel with a batter cell set to the battery to supply a peak power generated in the system, a leak-current prevention unit for preventing a leak current circulating from the battery cell to the peak-power supply unit, a connection determination unit for determining that the battery is not connected to the system, and a recognition unit for recognizing that the system is kept in a small-power-consumption mode.

In this case, the leak-current prevention unit disconnects the peak-power supply unit from the battery cell by a circuit based on the determination that the battery is not connected to the system by the connection determination unit and the recognition that the system is kept in a small-power-consumption mode by the recognition unit. The small-power-consumption mode includes a standby state, a suspended state, a soft-off state, and the system powered-off state. Therefore, it is possible to say that the small-power-consumption mode is a state in which no peak power is generated, a peak power may be hardly generated, or a peak power may not easily generated.

From another viewpoint, the present invention is a computer equipment connecting with a battery to supply power from the battery to the system and the battery comprises a battery cell for supplying power by discharging after being charged, a capacitor connected to a power line for supplying power from the battery cell to the system in parallel with the battery cell, a switch for turning on/off the connection of the capacitor to the power line, and a CPU for controlling the switch. The CPU controls the switch based on a connection state with the system and/or a power-consumption state of the system.

In this case, it is possible to determined the power-consumption state based on monitoring by a current-measuring circuit or a voltage-measuring circuit set in, for example, a battery pack. Moreover, the system comprises a controller for transmitting a command about a power-consumption state to the CPU and the CPU can determine a power-consumption state based on the command. Moreover, the system comprises a pull-up resistance for the CPU of the battery to recognize a connection state with the system and the CPU can recognize whether the battery is connected based on a recognized voltage value.

Furthermore, the present invention is an intelligent battery connected to an electrical apparatus to supply power to the electrical apparatus by discharging after being charged, comprising a peak-power supply unit set separately from a cell for supplying power to supply a peak power generated by the electrical apparatus and a leak-current prevention unit for preventing a leak current generated by the peak-power supply unit. In this case, the leak-current prevention unit disconnects the peak-power supply unit by a circuit based on a connection state with a body and/or an operation mode of the body.

Furthermore, an intelligent battery to which the present invention is applied comprises a cell for supplying power through a predetermined power line, a high-capacity capacitor connected to the power line in parallel with the cell under a predetermined condition, a switch for disconnecting or connecting the high-capacity capacitor from or to the power line, and a CPU for controlling operations of the switch.

The CPU detects a state in which the cell is not connected to an electrical apparatus or a state in which it is unnecessary to supply a peak power to the electrical apparatus when the cell is set to the electrical apparatus and controls operations of the switch based on a detected state. Therefore, the CPU is superior in that it is possible to suppress a leak power generated in a high-capacity capacitor. The “state in which it is unnecessary to supply a peak power” includes a state in which a body is powered off and a state in which the body is kept in a small-power-consumption mode.

From the viewpoint of the category of a method, the present invention is a power-supply control method of a battery for consuming power and connected to a body for generating a peak power to supply power to the body by discharging after being charged, comprising a step of supplying power from the cell of the battery to the body under the steady state of power in the body and supplying power from a capacitor connected in parallel with the cell of the battery when a peak power is generated in the body and a step of disconnecting the capacitor from the battery by a circuit when the battery is not connected to the body and/or the body does not have to supply a peak power.

Moreover, the present invention is a power-supply control method for supplying power from a battery in which a high-capacity capacitor is connected in parallel with a cell to a body, comprising a step of determining a state in which it is unnecessary to supply a peak power from the battery to the body or not and a step of disconnecting the cell from the high-capacity capacitor by a circuit when the state in which it is unnecessary to supply the peak power is determined. In this case, the “state in which it is unnecessary to supply the peak power” includes a state in which the battery is disconnected from the body and a state in which the body is powered off or kept in a predetermined small-power-consumption state. As one aspect, it is possible to recognize a state of a body based on a command transmitted from the body to a battery and determine a state in which it is unnecessary to supply a peak power or not.

### BRIEF DESCRIPTION OF THE SEVERAL VIEWS OF THE DRAWINGS

Some of the purposes of the invention having been stated, others will appear as the description proceeds, when taken in connection with the accompanying drawings, in which:

FIG. 1 is an illustration showing a hardware configuration of a computer system serving as an electrical apparatus to which the present embodiment is applied;

FIG. 2 is an illustration showing a first circuit configuration of a power-supply circuit to which the present embodiment is applied;

FIG. 3 is a flowchart showing the processing performed by a CPU of an intelligent battery;

FIG. 4 is an illustration showing a second circuit configuration of a power-supply circuit to which the present embodiment is applied; and

FIG. 5 is an illustration showing a state in which a high-capacity capacitor is connected in parallel with a battery.

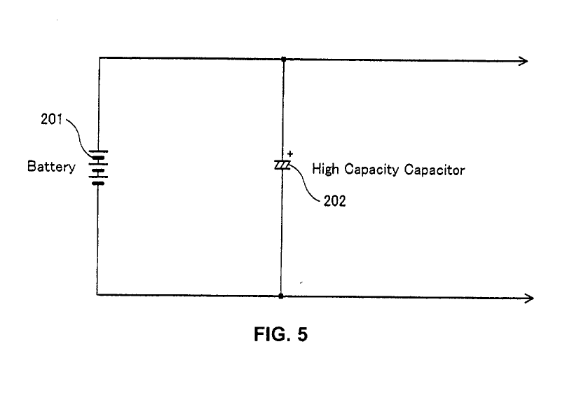

### DETAILED DESCRIPTION OF THE INVENTION

While the present invention will be described more fully hereinafter with reference to the accompanying drawings, in which a preferred embodiment of the present invention is shown, it is to be understood at the outset of the description which follows that persons of skill in the appropriate arts may modify the invention here described while still achieving the favorable results of the invention. Accordingly, the description which follows is to be understood as being a broad, teaching disclosure directed to persons of skill in the appropriate arts, and not as limiting upon the present invention.

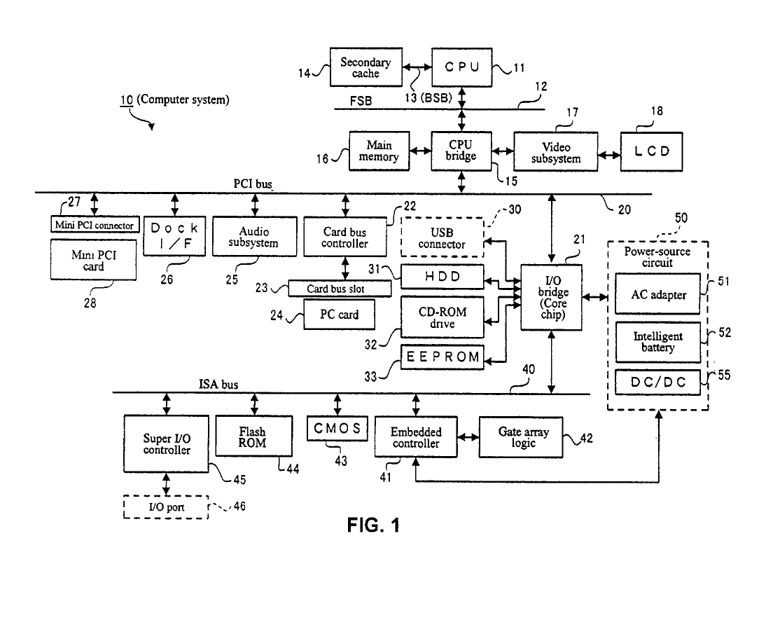

FIG. 1 is an illustration showing a hardware configuration of a computer equipment 10 which is an electrical apparatus to which the embodiment is applied. A computer equipment having the computer equipment 10 is constituted as a notebook PC (notebook-type personal computer) mounting a predetermined OS based on the OADG (Open Architecture Developer's Group) specification.

In the case of the computer system 10 shown in FIG. 1, a CPU 111 functions as a brain of the whole computer system 10 and executes various programs in addition to a utility program under the control by an OS. The CPU 11 is connected with various components through buses of three stages such as an FSB (Front Side Bus) 12 serving as the system bus, a PCI (Peripheral Component Interconnect) bus 20 serving as a bus for a high-speed I/O device, and an ISA (Industry Standard Architecture) bus 40 serving as a bus for a low-speed I/O device. The CPU 11 accelerates the processing speed by storing a program code and data in a cash memory. In recent years, an SRAM of approx. 128 KB is integrated in the CPU 11 as a primary cash memory. However, to supplement a capacity, a secondary cash 14 of 512 KB to 2 MB is set through a BSB (Back Side Bus) 13 which is an exclusive bus. It is also possible to reduce the cost by omitting the BSB 13 and connecting the secondary cash 14 to the FSB 12 to avoid a package having many terminals.

The FSB 12 and PCI bus 20 are connected each other by a CPU bridge (host-PCI bridge) 15 referred to as a memory/PCI chip. The CPU bridge 15 is constituted so as to have a memory control function for controlling access operations to a main memory 16 and include a data buffer for absorbing the difference between data transfer rates of the FSB 12 and PCI bus 20. The main memory 16 is a writable memory used as an area in which the execution program of the CPU 11 is read or a work area in which the processing data of the execution program is written. For example, the main memory 16 is constituted by a plurality of DRAM chips and normally provided with 64 MB and can be extended up to 320 MB. The execution program includes firmware such as various drivers for hardware-operating an OS and peripheral units, an application program for a specific business, and a BIOS (Basic Input/Output System) stored in a flash ROM 44 to be mentioned later.

A video subsystem 17 is a subsystem for realizing a function relating to video and includes a video controller. The video controller processes a drawing instruction output from the CPU 11, writes the processed drawing information in a video memory, reads the drawing information from the video memory, and outputs the information to a liquid-crystal display (LCD) 18 as drawing data.

The PCI bus 20 is a bus capable of transferring data at a comparatively high speed and standardized by the specification specifying a data bus width as 32 or 64 bits, the maximum operation frequencies as 33 MHz and 66 MHz, and the maximum data transfer rates as 132 MB/sec and 528 MB/sec. The PCI bus 20 connects with an I/O bridge 21, a card bus controller 22, an audio subsystem 25, a docking station interface (Dock I/F) 26, and a mini-PCI connector 27.

The card bus controller 22 is an exclusive controller for directly connecting a bus signal of the PCI bus 20 to an interface connector (card bus) of a card bus slot 23 and a PC card 24 can be loaded in the card bus slot 23. The docking station interface 26 is hardware for connecting a docking station (not illustrated) serving as a function extender of the computer system 10. When a notebook PC is set to the docking station, various hardware elements connected to an internal bus of the docking station are connected to the PCI bus 20 through the docking station interface 26. Moreover, the mini-PCI connector 27 connects with a mini-PCI card 28.

The I/O bridge 21 has a bridge function between the PCI bus 20 and the ISA bus 40. Moreover, the I/O bridge has a DMA controller function, programmable interrupt controller (PIC) function, programmable interval timer (PIT) function, IDE (Integrated Device Electronics) interface function, USB (Universal Serial Bus) function, and SMB (System Management Bus) interface function and has a built-in real-time clock (RTC).

The DMA controller function is a function for executing data transfer between a peripheral unit such as an FDD and the main memory 16 without using the CPU 11. The PIC function is a function for responding to an interrupt request (IRQ) from a peripheral unit and executing a predetermined program (interrupt handler). The PIT function is a function for generating a timer signal at a predetermined cycle. Moreover, an interface realized by the IDE interface function connects with an IDE hard disk drive (HDD) 31 and ATAPI (AT Attachment Packet Interface)-connects with a CD-ROM drive 32. It is allowed that the interface connects with an IDE device of another type such as a DVD (Digital Versatile Disk) instead of the CD-ROM drive 32. External memories of the HDD 31 and CD-ROM drive 32 are housed in a housing place referred to as a “media bay” or “device bay” in the body of a notebook PC. These normally-provided external memories may be exclusively set so that they can be replaced with other type of unit such as an FDD or battery pack.

Moreover, the I/O bridge 21 has a USB port and the USB port connects with a USB connector 30 set on, for example, the wall of a notebook PC. Furthermore, the I/O bridge 21 connects with an EEPROM 33 through an SM bus. The EEPROM 33 is a memory for storing the information such as a password, supervisor password, and product serial number entered by a user, which is nonvolatile and whose data can be electrically rewritten.

Furthermore, the I/O bridge 21 connects with a power-source circuit 50. The power-source circuit 50 comprises such circuits as an AC adapter 51 connected to a 100-VAC commercial power source to perform AC/DC conversion, an intelligent battery 52 serving as a battery (secondary battery) constituted by a nickel-hydrogen battery or nickel-cadmium battery used while repeating charge and discharge, and a DC/DC converter (DC/DC) 55 for generating DC constant voltages such as +15 V, +5 V, and +3.3 V used by the computer system 10. The intelligent battery 52 is a battery having a built-in CPU to communicate with an embedded controller 41 (to be described later) based on, for example, the SBS (Smart Battery System). Instead, however, it is also possible to use the so-called dumb battery having no built-in CPU. In the case of this embodiment, the intelligent battery 52 is constituted so that it can be set to or removed from the system of a notebook PC as a battery pack.

Moreover, an internal register for controlling the power-source state of the computer system 10 and a logic (state machine) for controlling the power-source state of the computer system 10 including the operation of the internal register are set in a core chip constituting the I/O bridge 21. The logic transceives various types of signals with the power-source circuit 50 and recognizes an actual state for supplying power from the power-source circuit 50 to the computer system 10 by transceiving the signals. The power-source circuit 50 controls power supply to the computer system 10 based on an instruction from the logic.

The ISA bus 40 is a bus having a data transfer rate lower than that of the PCI bus 20 (e.g. bus width of 16 bits and maximum data transfer rate of 4 MB/sec). The ISA bus 40 connects with an embedded controller 41, CMOS 43, flash ROM 44, and super I/O controller 45 connected to a gate array logic 42. Moreover, the ISA bus 40 is used to connect a peripheral unit operating at a comparatively low speed such as a keyboard/mouse controller. An I/O port 46 is connected to the super I/O controller 45 to control driving of an FDD, input/output of parallel data (PIO) through a parallel port, and input/output of serial data (SIO) through a serial port.

The embedded controller 41 controls a not-illustrated keyboard and is connected to the power-source circuit 50 and bears some of power-source control functions together with the gate array logic 42 by a power management controller (PMC).

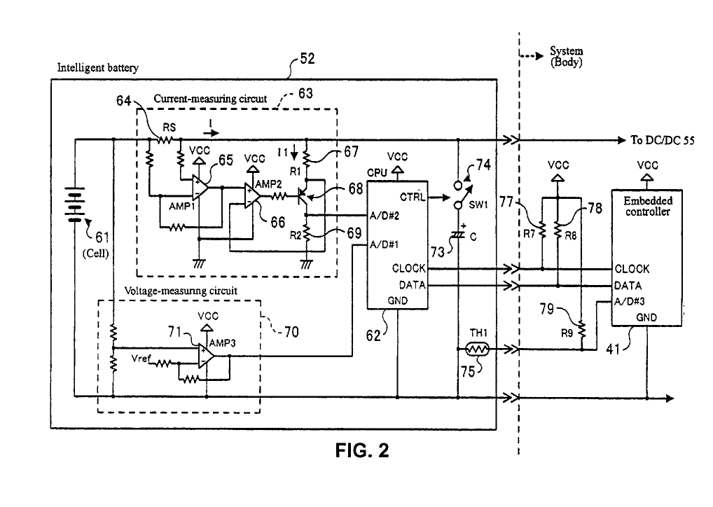

FIG. 2 is an illustration showing a first circuit configuration of a power-supply circuit to which this embodiment is applied. The power-supply circuit in FIG. 2 shows the intelligent battery 52 serving as a secondary battery (battery or storage battery) constituted by a lithium ion battery used while repeating charge and discharge and conforming to the SBS (Smart Battery System) and the embedded controller 41 for communicating with the intelligent battery 52. Moreover, a resistance (R7) 77, resistance (R8) 78, and resistance (R9) 79 respectively serving as a pull-up resistance are set between the embedded controller 41 and the intelligent battery 52. These resistances are connected to a voltage Vcc. A CPU 62 (to be described later) of the intelligent battery 52 can determine whether the intelligent battery 52 is connected to the system based on whether CLOCK line and DATA line are kept at a voltage-Vcc level.

Then, the internal configuration of the intelligent battery 52 serving as a battery pack or the like is described below. As shown in FIG. 2, the intelligent battery 52 comprises a cell (battery cell) 61 constituted by a plurality of single cells serving as a battery which is charged and discharges, a CPU 62 for controlling the intelligent battery 52 and communicating with the embedded controller 41, a current-measuring circuit 63 for obtaining a current value charged to or discharged from the cell 61, and a voltage-measuring circuit 70 for obtaining a voltage of the cell 61. The cell 61 is a lithium-ion-grouped battery constituted by six two-parallel three-series (1.8 Ah/cell) cells.

Moreover, this embodiment comprises a high-capacity capacitor 73 serving as a electric double-layer capacitor, a switch (SW1) 74 for connecting (on) or disconnecting (off) the high-capacity capacitor 73 to or from a power line, and a thermistor (TH1) 75 capable of connecting with the embedded controller 41. It is preferable that the high-capacity capacitor 73 has an ESR (Equivalent Series Resistance) of 10 to 100 mW and a capacitance of 0.1 F to tens of Fs, which is connected with the cell 61 in parallel and whose peak power is supplied to the system. The high-capacity capacitor 73 decreases a peak power discharged from the cell 61 of the intelligent battery 52 as the peak power of the computer system 10 and is resultantly used to increase the driving time of the intelligent battery 52. That is, because a peak power is furnished by the high-capacity capacitor 73, the intelligent battery 52 serving as a battery pack does not stop supply of power since the over-current protection or low-voltage protection of the intelligent battery 52 functions.

The switch (SW1) 74 has a function for disconnecting the high-capacity capacitor 73 by a circuit when it is unnecessary to supply a peak power to the system side based on a CTRL signal output from the CPU 62 and connecting the high-capacity capacitor 73 by a circuit when it is necessary to supply a peak power to the system side. The switch (SW1) 74 can be realized by an electronic circuit using a mechanical switch, transistor, or field-effect transistor (FET).

The CPU 62 set in the intelligent battery 52 internally A/D (Analog to Digital)converts an analog signal which is a measurement result input from the current-measuring circuit 63 or voltage-measuring circuit 70 and holds a current output from the cell 61. Moreover, the CPU 62 holds various pieces of information relating to a battery such as the capacity of the battery. Furthermore, the CPU 62 transmits the held output current and various pieces of information relating to a battery to the embedded controller 41 of the system side by using, for example, the SBS protocol through two communication lines DATA and CLOCK. Moreover, as described above, the CPU 62 controls the CTRL signal and turns on/off the switch (SW1) 74.

In the case of the current-measuring circuit 63, a potential difference of a voltage I′RS is first generated at the both ends of a resistance (RS) 64 by a current I supplied from the cell 61. The voltage is differentially amplified by an operational amplifier (AMP1) 65. Moreover, a current I′1 proportional to an output voltage of the operational amplifier (AMP1) 65 circulates through a resistance (R1) 67. Finally, the value of the current I of the intelligent battery 52 can be converted into a voltage (I1′R2) generated in a resistance (R2) 69. The voltage (I1′R2) is input to the A/D#2 port of the CPU 62 and A/D-converted by the CPU 62.

The voltage-measuring circuit 70 measures the voltage of the intelligent battery 52. Specifically, the voltage of the cell 61 in the intelligent battery 52 is dropped to a low voltage through resistance division and differentially amplified by an operational amplifier (AMP 3) 71 and then, input to the A/D#1 port of the CPU 62 and A/D-converted by the CPU 62.

In this case, a peak power denotes the power larger than a steady state necessary in a certain short period for the power supplied in a steady state. That is, a peak power denotes a large power necessary for a certain fine range or necessary instantaneously and is distinguished from an average power. Moreover, a peak power is a pulsate (angular) power. For example, there is a case in which a peak power of 50 W is consumed in a short time while power of 30 W is consumed in a steady state.

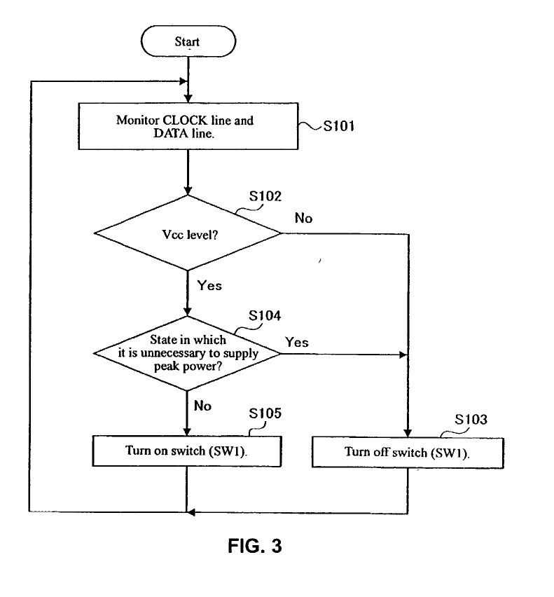

FIG. 3 is a flowchart showing the processing executed by the CPU 62 of the intelligent battery 52. The CPU 62 first monitors CLOCK line and DATA line (step 101) to check whether these lines are kept at Vcc level (step 102). In the case of this embodiment, the resistances 77 (R7) and 78 (R8) which are pull-up resistances are connected to two communication lines CLOCK and DATA serving as interfaces of a standard SBS. When the intelligent battery 52 (battery pack) is removed from the system, it loses the pull-up resistances and it can be detected that the both communication lines become open. That is, when CLOCK and DATA lines are not set to Vcc, it is possible that the intelligent battery 52 is not connected to the system and it is unnecessary to supply a peak power to the system. Therefore, a leak current is prevented from being generated by the cell 61 by controlling a CTRL signal and thereby turning off the switch (SW1) 74 (step 103). Cases in which the intelligent battery 52 is powered off though it is connected and moreover, the AC adapter 51 is not connected are considered in addition to a case in which the CPU 62 does not detect pull-up in step 102.

Moreover, when it is recognized that CLOCK and DATA lines are kept at Vcc level in step 102, it is determined whether the state is a state in which it is unnecessary to supply a peak power (step 104). The state in which it is unnecessary to supply a peak power includes small-power-consumption states such as a power-off state, a soft-off state (a state in which a power source is turned off by software, that is a state of supplying power to only some of circuits in a body in order to realize the WOL (Wake On Lan) function by the fact that an external signal is received and the body operates through the current state is a power-off state), a suspended state in which supply of power to peripheral units is stopped and only the minimum power required to hold data is supplied or a state in which the body is immediately operated by opening the LCD 18 or pressing a specific key though the current state is a stop state but no power is supplied to the CPU 11 of the body), or a standby state (state in which the system is in an idle state and no peak power is consumed through powered on but power is supplied to the CPU 11 of the body). A method for detecting the above state will be described later in detail.

When it is unnecessary to supply a peak power in step 104, step 103 is restarted to control a CTRL signal and turn off the switch (SW1) 74. In the case of not a state in which it is unnecessary to supply a peak power (that is, when it is necessary to supply a peak power), a CTRL signal is controlled and the switch (SW1) 74 is turned on (step 105) and step 101 is restarted. As a result, the high-capacity capacitor 73 and the cell 61 are connected in parallel and a peak power is supplied from the high-capacity capacitor 73 to the system.

Then, a method for detecting a state in which it is unnecessary to supply a peak power depending on a state of the small-power-consumption mode even if connected to the system to be executed in step 103 in FIG. 3 is described below. The detection method includes a method of using the current-measuring circuit 63 in the intelligent battery 52 (battery pack) and a method for the intelligent battery 52 to receive a state of the system.

First, in the case of the method of using the current-measuring circuit 63 in the battery pack, the intelligent battery 52 has the current-measuring circuit 63 and voltage-measuring circuit 70 shown in FIG. 2 in the battery pack to monitor the remaining capacity of the cell 61. For example, when assuming the current consumption of the system under standby state as 50 mA and the current consumption of the system under normal operation as 500 mA, the CPU 62 turns off the switch (SW1) 74 because it is possible to determine the standby state by the current-measuring circuit 63 when the discharge current value of the cell 61 is 100 mA or less. Because a state is under normal operation when the discharge current value is larger than 100 mA, the CPU 62 turns on the switch (SW1) 74 by controlling a CTRL signal in order to supply a peak power from the high-capacity capacitor 73.

Then, in the case of a method for the intelligent battery 52 to receive a state of the system, a case in which the intelligent battery 52 is a battery conforming to the SBS is described below as an example. The SBS does not include a command for communicating a state of the system to the intelligent battery 52. Therefore, by defining the OptionalMfgFunction command, a state of the system is communicated to the intelligent battery 52. In this case, OptionalMfgFunction1 is used. The following is an example of command definition.

OptionalMfgFunction1 . . . Command Code: Ox3f, Access: Read/Write Word bit

15-0: 0x00 . . . Normal Operation

0x01 . . . Standby State

The embedded controller 41 of the system side sends the OptionalMfgFunction1 command and the data 0x01to the intelligent battery 52 when entering the standby state. When receiving the data 0x01, the CPU 62 of the intelligent battery 52 controls a CTRL signal to turn off the switch (SW1) 74. When turning to the normal operation the system sends the OptionalMfgFunction1 command and the data 0x00from the embedded controller 41 to the intelligent battery 52. When receiving the data 0x00, the CPU 62 of the intelligent battery 52 controls the CTRL signal to turn on the switch (SW1) 74.

Thus, according to this embodiment, when the intelligent battery 52 is not connected to the system or even if the battery 52 is connected to the system, when it is unnecessary to supply a peak power due to power-off or small-power-consumption mode such as a standby state, the CPU 62 of the intelligent battery 52 can prevent a leak current generated by the high-capacity capacitor 73 by controlling the CTRL signal and turning off the switch (SW1) 74.

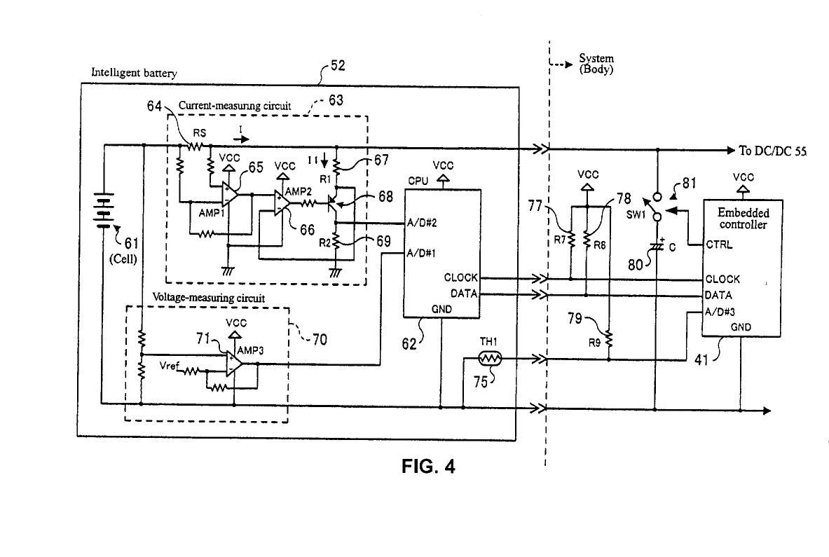

FIG. 4 is an illustration showing a second circuit configuration of a power-supply circuit to which this embodiment is applied. In the case of the first circuit configuration shown in FIG. 2, the high-capacity capacitor 73 is set in the intelligent battery 52 to turn on/off the switch (SW1) 74 under the control by the CPU 62 set in the intelligent battery 52. The configuration in FIG. 4 is different from that in FIG. 2 in that a high-capacity capacitor is set in the system. That is, in the case of the power-supply circuit in FIG. 4, a high-capacity capacitor 80 is connected in parallel with the output side of the intelligent battery 52 in the system and moreover, a switch (SW1) 81 for disconnecting the high-capacity capacitor 80 by a circuit is set in the system. Turning-on/off of the switch (SW1) 81 is controlled by the embedded controller 41.

That is, the embedded controller 41 reads the voltage of a terminal A/D#3 and determines that the intelligent battery 52 is not connected when the voltage value is equal to Vcc. However, when the voltage of the terminal A/D#3 has a voltage value obtained by dividing the voltage Vcc with resistance values of a resistance (R9) 79 and a thermistor (TH1) 75, the controller 41 determines that the intelligent battery 52 is connected. When the intelligent battery 52 is not connected, the embedded controller 41 turns off the switch (SW1) 81 based on a CTRL signal to disconnect the high-capacity capacitor 80 from the power line of the intelligent battery 52. However, unless the intelligent battery 52 is connected, no leak current circulates through the high-capacity capacitor 80 as long as the power line is not connected. Therefore, it is possible to omit the above processing.

Moreover, because the embedded controller 41 is a controller for controlling the power management of the system, it recognizes states of the system such as normal operation, small-power-consumption mode, and power-off. Therefore, the embedded controller 41 turns off the switch (SW1) 81 by controlling a CTRL signal in order to prevent a leak current from occurring when the system is kept in the small-power-consumption mode or is powered off and turns on the switch (SW1) 81 while the system is normally operated.

Thus, in the case of this embodiment, a peak power discharged from a battery is reduced when the peak power of the system is generated by arranging the high-capacity capacitors 73 and 80 respectively constituted by a double-layer capacitor having a comparatively small impedance in parallel with the power line of the intelligent battery 52 and moreover, the peak power of the intelligent battery 52 is reduced. As a result, it is possible to lengthen the driving time of the intelligent battery 52. However, an action of disconnecting the high-capacity capacitors 73 and 80 from a power line at a proper timing to reduce the leak power of the intelligent battery 52 is taken in order to prevent a damage caused by over-discharge of the intelligent battery 52 due to a leak current present at hundreds of mAs to several mAs. Thereby, it is possible to realize the intelligent battery 52 capable of corresponding to a notebook PC including the CPU 11 having a large peak power.

The above circuit configuration shows the high-capacity capacitors 73 and 80 by a single device respectively. However, it is realistic to respectively constitute the capacitors 73 and 80 with a plurality of cells in view of a rated voltage and a capacitance. Moreover, this embodiment is described by using the intelligent battery 52 as an example. However, it is also possible to use a dumb battery not having the CPU 62 instead of the intelligent battery 52. In this case, the high-capacity capacitor 80 and the switch (SW1) 81 are set to the system side similarly to the circuit shown in FIG. 4 to detect presence or absence of a battery by using the pull-up resistance shown in FIG. 4 and operate the switch (SW1) 81 based on a state of the system. Thereby, it is possible to prevent a battery from damaging due to a leak current generated by the high-capacity capacitor 80.

In the drawings and specifications there has been set forth a preferred embodiment of the invention and, although specific terms are used, the description thus given uses terminology in a generic and descriptive sense only and not for purposes of limitation.

What is claimed is:

1. Apparatus comprising:
a body which consumes power;
a battery which supplies power to the body through a power line by discharging after being charged;
a high-capacity capacitor connected to the power line in parallel with the battery;
a switch for disconnecting or connecting the high-capacity capacitor from or to the power line by a circuit; and
a controller for controlling operations of the switch.

2. Apparatus according to claim 1, wherein the controller controls operations of the switch to disconnect the high-capacity capacitor by a circuit when the battery is disconnected from the body.

3. Apparatus according to claim 1, wherein the controller controls operations of the switch to disconnect the high-capacity capacitor by a circuit when the body is powered off and/or the body is kept in a small-power-consumption mode.

4. Apparatus according to claim 1, wherein the high-capacity capacitor and the switch are integrated so that they can be set to the body.

5. Apparatus comprising:
a body which consumes power;
a battery which supplies power to the body through a power line by discharging after being charged;
a peak-power supply unit connected to a power line and which supplies power to the bodyin parallel with the battery when a peak power demand is generated in the body; and
a disconnection unit for disconnecting the peak-power supply unit from the power line when the body is kept in a predetermined small-power-consumption mode and/or the body is powered off.

6. Apparatus according to claim 5, wherein the peak-power supply unit is a high-capacity capacitor disposed in the body.

7. Apparatus comprising:
a computer;
a battery connected with said computer and which supplies power to said computer by being discharged after being charged;
a peak-power supply unit connected in parallel with said battery cell and supplying peak power demands generated in said computer; and
a leak-current prevention unit for preventing a leak current circulating from said battery to said peak-power supply unit.

8. Apparatus according to claim 7, further comprising a connection determination unit for determining that the battery is not connected to the system, wherein said leak-current prevention unit disconnects said peak-power supply unit from said battery by a circuit based on the determination that the battery is not connected to said computer by said connection determination unit.

9. Apparatus according to claim 7, further comprising a recognition unit for recognizing that said computer is kept in a small-power-consumption mode, wherein said leak-current prevention unit disconnects said peak-power supply unit from said battery by a circuit based on the recognition that the system is kept in the small-power-consumption mode by said recognition unit.

10. Apparatus according to claim 9, wherein the small-power-consumption mode recognized by said recognition unit denotes any one of the standby state, suspended state, and soft-off state.

11. Apparatus comprising:
a computer;
a battery connected to said computer and which supplies power to said computer, said battery comprising a battery cell for supplying power by discharging after being charged;
a capacitor connected to a power line which supplies power to said computer in parallel with said battery cell;
an on/off switch which turns on and off the connection of said capacitor to the power line; and
a CPU which controls the switch based on a connection state with said computer and/or a power-consumption state of said computer.

12. Apparatus according to claim 11, further comprising a controller for transmitting a command about a power consumption state to the CPU.

13. Apparatus according to claim 11, further comprising a pull-up resistance for the CPU of the battery to recognize the connection state with the system.

14. An intelligent battery connected to an electrical apparatus to supply power to the electrical apparatus by discharging after being charged, comprising:
a peak-power supply unit set separately from a cell for supplying power to supply a peak power generated by the electrical apparatus; and
a leak-power prevention unit for preventing the leak current generated by the peak-power supply unit.

15. The intelligent battery according to claim 14, wherein the leak-current prevention unit disconnects the peak-power supply unit by a circuit based on a connection state with a body and/or an operation mode of the body.

16. An intelligent battery set to an electrical apparatus to supply power to the electrical apparatus by discharging after being charged, comprising:
a cell for supplying power through a predetermined power line; and
a high-capacity capacitor connected to the power line in parallel with the cell under a predetermined condition.

17. The intelligent battery according to claim 16, further comprising:
a switch for disconnecting or connecting the high-capacity capacitor from or to the power line by a circuit; and
a CPU for controlling operations of the switch.

18. The intelligent battery according to claim 17, wherein the CPU detects a state in which the cell is not connected to the electrical apparatus or a state in which it is unnecessary to supply a peak power to the electrical apparatus when the cell is set to the electrical apparatus and controls operations of the switch based on a detected state.

19. A method comprising the steps of:
supplying power from a cell of a battery to a power consuming body under the steady state of power demand in the body;
supplying power to the body from a capacitor connected in parallel to the cell of the battery when a peak power demand is generated in the body; and
disconnecting the capacitor from the battery when the battery is not connected to the body and/or when the power demand from the body is less than the peak power demand.

20. A method comprising the steps of:
supplying power to a power consuming body from a battery and a high-capacity capacitor connected in parallel with the battery;
determining whether it is unnecessary to supply a peak power demand from the battery to the body; and
disconnecting the high-capacity capacitor from the battery by a circuit when a state in which it is unnecessary to supply a peak power demand is determined.

21. The power-supply control method according to claim 20, wherein whether it is unnecessary to supply a peak power demand is determined by recognizing a state of the body based on a command transmitted from the body to the battery.
